(19) United States
(12) Patent Application Publication
(10) Pub. No.: US 2023/0328616 A1
(43) Pub. Date: Oct. 12, 2023

(54) WIRELESS COMMUNICATION APPARATUS, METHOD FOR CONTROLLING THE SAME, AND STORAGE MEDIUM

(71) Applicant: CANON KABUSHIKI KAISHA, Tokyo (JP)

(72) Inventors: YUICHI YAMAKAWA, Chiba (JP); YUKI YOSHIKAWA, Kanagawa (JP)

(21) Appl. No.: 18/296,853

(22) Filed: Apr. 6, 2023

(30) Foreign Application Priority Data
Apr. 12, 2022 (JP) 2022-065948

(51) Int. Cl. H04W 36/30; H04W 36/18

(52) U.S. Cl. CPC H04W 36/304; H04W 36/185

(57) ABSTRACT

A wireless communication apparatus including least a first station (STA) and a second STA, and being connectable with at least a first access point (AP) and a second AP in parallel, includes a detection unit configured to detect that a quality of communication with the first AP with which a connection is established fulfills a predetermined condition, and a connection unit configured to establish a connection with the second AP using the second STA in a case where the detection unit detects that a quality of communication with the first AP fulfills the predetermined condition in a state that a connection with the first AP is established using the first STA.

### BACKGROUND

### Field

The present disclosure relates to a wireless communication apparatus, a method for controlling the same, and a storage medium.

### Description of the Related Art

Known communication standards relating to a wireless local area network (LAN) include an Institute of Electrical and Electronics Engineers (IEEE) 802.11™ standard, and a Wi-Fi® standard laid down by the Wi-Fi Alliance®.

As a network configuration that complies with the IEEE 802.11™ standard, an infrastructure mode (infra mode) is known. With this infra mode, a station (STA) establishes a connection with an access point (AP) to participate in a network formed by the connected AP. The STA that has participated in the network formed by the AP can perform data communication with another communication apparatus via the connected AP.

It is known that in an environment where a plurality of APs is provided, the STA that has been connected to any AP in the infra mode switches the connected AP depending on an environment. The AP is switched to another AP, for example, in a case where a mobile phone that operates as the STA cannot receive a radio wave generated by the AP due to a location change of the mobile phone.

Normally, when a radio wave cannot be received from the connected AP, the connected AP is switched by executing processing for connecting with an AP with which a next connection is to be established.

In this case, a disconnection such as that data communication cannot be temporarily performed occurs because the connected AP is switched to the next AP. Thus, in order to reduce a time period during which the disconnection is occurring, the STA needs to switch an AP via which the data communication is performed during a time as short as possible.

With regard to the above issue, for example, Japanese Patent Application Laid-Open No. 2004-88592 discusses a system using a roaming technique. With this technique, a time period during which an STA switches one AP to another is reduced by receiving information about an AP with which next connection is to be established in advance from the AP that has established the connection.

### SUMMARY

According to an aspect of the present disclosure, a wireless communication apparatus including at least a first station (STA) and a second STA, and being connectable with at least a first access point (AP) and a second access point in parallel, includes a detection unit configured to detect that a quality of communication with the first AP with which a connection is established fulfills a predetermined condition, and a connection unit configured to establish a connection with the second AP using the second STA in a case where the detection unit detects that a quality of communication with the first AP fulfills the predetermined condition in a state that a connection with the first AP is established using the first STA.

Further features of the present disclosure will become apparent from the following description of exemplary embodiments with reference to the attached drawings.

### BRIEF DESCRIPTION OF THE DRAWINGS

FIG. 1 illustrates a network configuration of the present disclosure.

FIG. 2 illustrates a configuration of a terminal.

FIG. 3 is a flowchart 1 relating to connection of the terminal.

FIG. 4 is a flowchart 2 relating to the connection of the terminal.

FIG. 5 is a flowchart 1 relating to access point (AP) switch processing.

FIG. 6 is a flowchart 2 relating to the AP switch processing.

### DESCRIPTION OF THE EMBODIMENTS

Exemplary embodiments are to be described in detail with reference to the accompanying drawings. Configurations described in the following exemplary embodiments are merely examples, and the present disclosure is not limited to the configurations illustrated in the drawings.

An example of a wireless local area network (LAN) system that conforms to the Institute of Electrical and Electronics Engineers (IEEE) 802.11™ standard will be described. The wireless LAN system may conform to other communication standards such as Bluetooth (registered tradename), Near Field Communication (NFC), ultra wide band (UWB), Zigbee, and Multi Band Orthogonal Frequency Division Multiplexing Alliance (MBOA) besides the IEEE 802.11™ standard. The UWB includes wireless universal serial bus (USB), wireless 1394, and the like. The following exemplary embodiments do not limit the claimed disclosure. The exemplary embodiments describe a plurality of features, but not all the plurality of features is essential for the disclosure, and the plurality of features may be combined in any way. Further, in the accompanying drawings, identical or similar components in the configuration are denoted by identical reference numerals, and the overlapped portions of the description are omitted.

A first exemplary embodiment is to be described below.

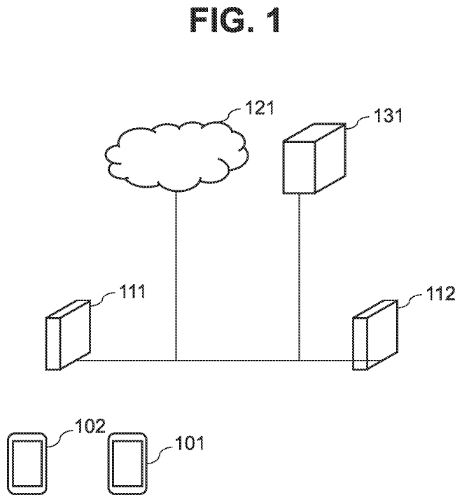

FIG. 1 illustrates a network configuration to which the present disclosure is applicable. In FIG. 1, the network configuration includes terminals 101 and 102. The terminal 101 is, for example, a printer having a print function of printing an image, and receives image data to be printed via an access point (AP), as described below. Further, the terminal 101 may be a camera, a personal computer (PC), a television (TV), a projector, an internet of things (IoT) device such as a smart home appliance, or a smart device such as a smart phone or a tablet. That is, the terminal 101 may be a wireless communication apparatus having a plurality of stations (STAs).

APs 111 and 112 each can establish a connection with the terminal 101 by execution of connection processing. The APs 111 and 112 each may be a wireless communication apparatus having an AP function, and thus may be a wireless rooter or modem, a smart device such as a smart phone, a tablet, or a smart watch, or a personal computer (PC). The terminal 101 can be selectively connected to the AP 111 or 112 in a case where the terminal 101 is capable of receiving radio waves from the APs 111 and 112.

The Internet 121 may be, for example, wide area network (WAN) or a local area network (LAN).

A data server 131 is connected to the APs 111 and 112 via the LAN. Data communication with the data server 131 can be performed via the AP 111 or 112.

In the network configuration illustrated in FIG. 1, the terminal 101 can perform data communication with another communication apparatus in an infrastructure mode (infra mode). The infra mode means a network configuration where data communication with another communication apparatus is performed via an AP with which the terminal 101 has established a connection. For example, it is assumed that the terminal 101 establishes a connection with the AP 111. The terminal 101 establishes the connection with the AP 111 to participate in a network formed by the AP 111. The terminal 101 that has participated in the network formed by the AP 111 can perform data communication with the Internet 121 and the data server 131 via the AP 111.

The terminal 101 participates in the network formed by the AP 111 so that the terminal 101 can perform, via the AP 111, data communication with another communication apparatus, such as the terminal 102, that participates in the network formed by the AP 111. The connection here means at least logical association.

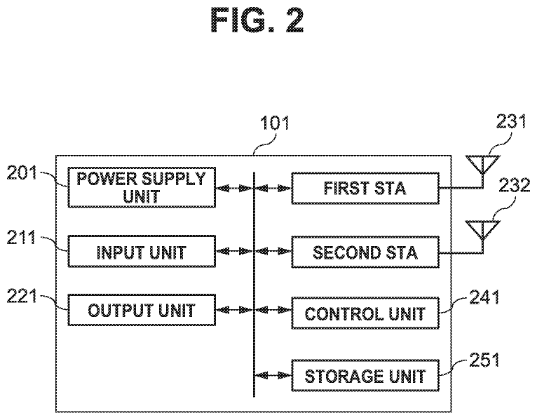

FIG. 2 illustrates a configuration of the terminal 101.

A power supply unit 201 supplies power to each piece of hardware. The power supply unit 201 acquires electric power from, for example, an alternate current (AC) power supply or a battery.

An input unit 211 accepts various operations from a user. The various operations are performed with, for example, an operation button.

An output unit 221 performs various output for a user. The output by the output unit 221 includes, for example, display using a light emitting diode (LED), display on a screen, sound output using a speaker, and vibration output. Like a touch panel, both the input unit 211 and the output unit 221 may be achieved by one module. The input unit 211 and the output unit 221 do not necessarily need to be built in the terminal 101, and may perform input and output at a terminal different from the terminal 101.

A first STA 231 and a second STA 232 perform wireless LAN control and transmission/reception of radio waves, conforming to the IEEE 802.11 standard to be connected with an AP. The terminal 101 is configured so that two STAs can operate in parallel and establish a connection with two APs in parallel. The terminal 101 may have three or more STAs, and any number of the STAs can operate in parallel. In the description of the present exemplary embodiment, the two STAs are used, but the present disclosure is not limited to this example, and the terminal 101 may establish a connection with at least two APs in parallel.

A control unit 241 includes a processor such as a central processing unit (CPU) or a micro processing unit (MPU). The control unit 241 may execute a program stored in a storage unit 251 to entirely control the terminal 101. Instead of the entire control of the terminal 101 by the control unit 241, one or more pieces of hardware may share the processing to entirely control the terminal 101.

The storage unit 251 includes a memory such as a read only memory (ROM) or a random access memory (RAM), and stores programs for executing various pieces of processing, and various pieces of information, as described below.

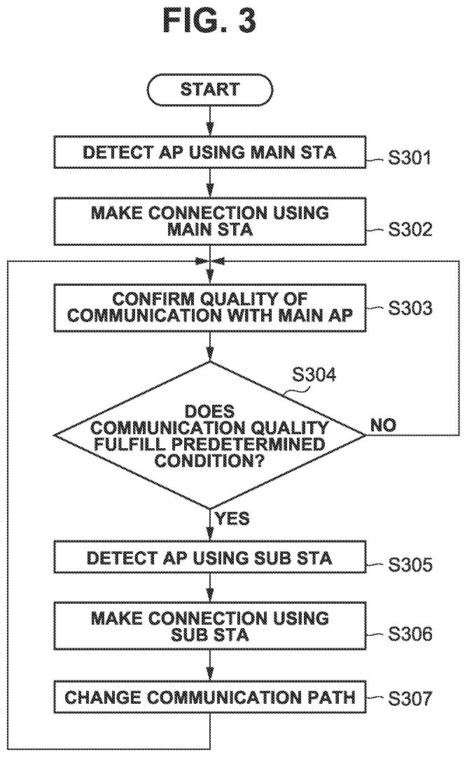

FIG. 3 is a flowchart relating to the connection of the terminal 101. A main STA in the present exemplary embodiment is used for establishing a connection with an AP via which the terminal 101 performs data communication. The terminal 101 establishes a connection with a main AP using the main STA. Further, the terminal 101 establishes a connection with a sub AP using a sub STA other than the main STA.

The terminal 101 executes AP detection processing (step 5301) for detecting connectable ambient APs using the STA based on the operation performed by the user with the input unit 211. The AP detection processing in step 5301 may be started based on control by the control unit 241 or based on a power-on operation of the terminal 101.

The terminal 101 establishes connections with the APs detected in the AP detection processing in step 5301 using the STA (step S302). First, the terminal 101 may transmit and receive a probe request frame and a probe response frame between the STA and APs. The terminal 101 transmits and receives an authentication request frame and an authentication response frame. The terminal 101 transmits and receives an association request frame and an association response frame. A sequence of these operations is referred to as connection processing. After transmitting and receiving the association frames, the terminal 101 may execute encryption processing for communication. In the encryption processing, the terminal 101 executes, for example, 4-way handshake processing. In the 4-way handshake processing, the terminal 101 executes this processing four times between the STA and APs to generate a pairwise transient key (PTK) that is an encryption key for unicast and a group temporal key (GTK) that is an encryption key for multicast and broadcast. The connection processing may include the sequence of operations for the above-described encryption processing.

For example, the terminal 101 may display the information about the APs detected in the AP detection processing in step S301 on the output unit 221. The terminal 101 may allow the user to select, with the input unit 211, an AP to be connected from the APs displayed on the output unit 221. The terminal 101 may allow the user to select an STA to be used for the connection. In such a manner, the terminal 101 may accept the selections from the user, and select the AP to be connected with the STA to be used for connection, based on the selections by the user, to execute the connection processing. The terminal 101 may select the AP to be connected from the plurality of APs detected in the AP detection processing, based on automatic selection by the control unit 241.

When the terminal 101 is to be connected with the AP, the user may be required to input a password necessary for encryption depending on an encryption method of a wireless LAN set in the AP. In this case, the terminal 101 may display a password input screen after selecting the AP to be connected and allow the user to input a password.

After the terminal 101 is connected with the AP, the terminal 101 may record information necessary for the connection with the AP as an AP setting record in the storage unit 251. The information for the connection with the AP includes a service set identifier (SSID), a security type, and a password. The information for the connection with the AP may be used for the automatic connection with the AP without an operation by the user. In the present exemplary embodiment, in the main STA connection processing in step S302, the terminal 101 establishes a connection with the AP 111 using the first STA 231.

The terminal 101 (detection unit) confirms a quality of communication with the main AP (step S303). The communication quality is determined based on a radio wave strength and a signal-to-noise ratio of a radio wave generated from the AP, such as a received signal strength indicator (RSSI) and a signal noise rate (SNR). In the communication quality confirmation processing in step S303, the terminal 101 confirms the communication quality of the main AP based on, for example, information acquired from a beacon generated by the main AP and from a signal received from the main AP in the infra mode.

In a case where it is detected that the quality of the communication with the main AP fulfills a predetermined condition, based on the result of the communication quality confirmation processing in step S303 (Yes in step S304), the processing proceeds to AP detection processing in step S305 using a sub STA. In a case where it is detected that the quality does not fulfill the predetermined condition (No in step S304), the processing proceeds to the communication quality confirmation processing in step S303, and the terminal 101 confirms the communication quality again. The case where the quality of the communication with the main AP fulfills the predetermined condition means, for example, a case where any value of the above-described criterion for the communication quality is under a preset threshold.

The terminal 101 detects a connectable AP other than the main AP using a sub STA (step S305). The terminal 101 establishes a connection with the AP detected in the AP detection processing in step S305 using the sub STA in accordance with the procedure similar to the main STA connection processing in step S302 (step S306). In the present exemplary embodiment, in the connection processing in step S306, the terminal 101 establishes a connection with the AP 112 using the second STA 232.

After establishing the connection with the sub AP, in communication path change processing in step S307, the terminal 101 changes a communication path via the main AP to a communication path via the sub AP. In the present exemplary embodiment, in the communication path change processing in step S307, the terminal 101 automatically changes a communication path via the AP 111 to a communication path via the AP 112 in the data communication with the data server 131. However, the communication path may be changed in response to an explicit instruction from the user. The terminal 101 may disconnect the main AP upon the establishment of the connection with the sub AP or upon the change of the communication path.

The plurality of STAs is disposed so that the connection with the plurality of APs can be efficiently established. For example, in a state where the connection with the AP has been established using one STA, a connection with an AP that has not established a connection can be additionally established by using another STA.

The communication path is changed while the connection with the plurality of APs is established in parallel using the plurality of STAs, so that an AP via which data communication is performed can be switched efficiently.

In the present exemplary embodiment, the AP detection processing using a sub STA is started based on the detection that the quality of the communication with the main AP fulfills the predetermined condition, but the present disclosure is not limited to this example. For example, a connectable AP may be detected every predetermined time by using a sub STA regardless of the communication quality of the main AP. The detection processing using a sub STA may be executed in parallel with the conformation of the quality of the communication with the main AP. In the present exemplary embodiment, the wireless communication apparatus including the plurality of STAs can efficiently establish a connection with an AP that has not established a connection when the quality of communication with the connected AP fulfills the predetermined condition.

In the first exemplary embodiment, in a state where a connection with a certain AP is established, a connection with another AP is additionally established using the plurality of STAs, so that the connection can be efficiently established. A communication path is changed while connections with different APs in parallel are established using the plurality of STAs, so that an AP via which data communication is performed is switched during a disconnection time shorter than normal.

A second exemplary embodiment of the present disclosure is to be described below. The configuration relating to the terminal 101 and the APs 111 and 112 is similar to that in FIGS. 1 and 2. The present exemplary embodiment is different from the first exemplary embodiment in that, before establishing a connection with a sub AP using a sub STA, the terminal 101 compares the communication quality of a connectable AP (AP as a candidate for the sub AP) with the communication quality of the main AP, so that the main AP can be switched to an AP with higher communication quality.

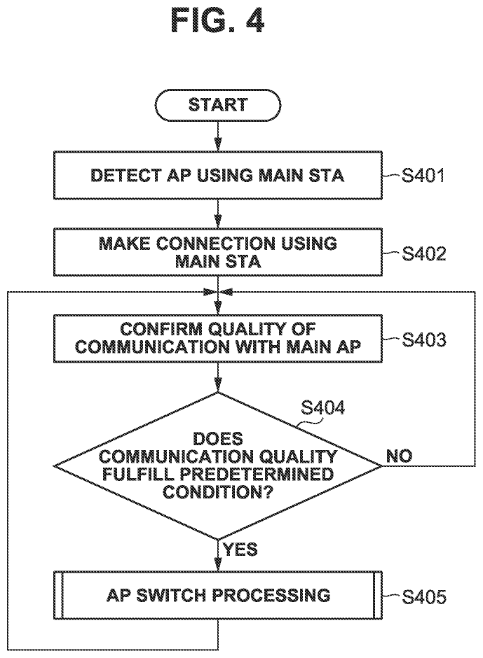

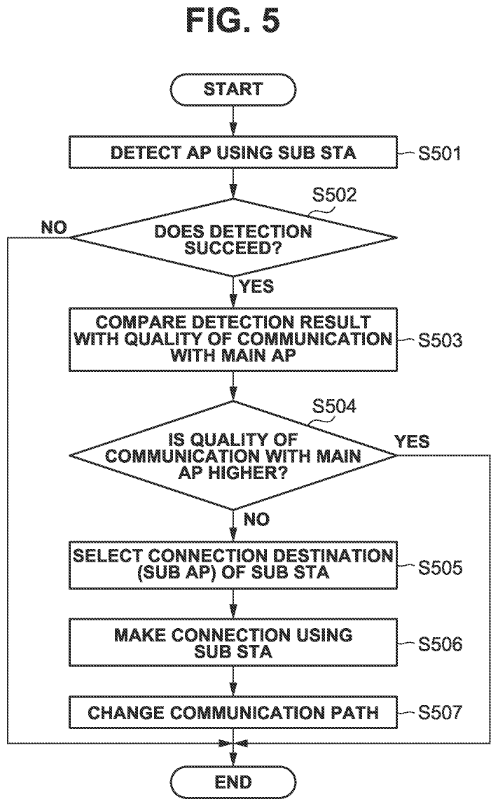

The present exemplary embodiment is to be described with reference to FIGS. 4 and 5. FIG. 4 is a flowchart relating to the connection of the terminal 101 according to the present exemplary embodiment. Also in the present exemplary embodiment, the terminal 101 uses a main STA for establishing a connection with a main AP that is used in the infra mode. Further, the terminal 101 uses a sub STA other than the main STA for establishing a connection with a sub AP.

Steps S401 to S404 in FIG. 4 are similar to steps S301 to S304 in FIG. 3. In the present exemplary embodiment, in a case where the terminal 101 detects that the quality of the communication with the main AP fulfills the predetermined condition, based on the result in communication quality confirmation processing in step S403 (Yes in step S404), the processing proceeds to AP switch processing in step S405.

The AP switch processing in step S405 is to be described in detail with reference to a flowchart 1 relating to the AP switch processing in FIG. 5. The terminal 101 has been already connected with the AP 111 using the first STA 231, and performs data communication with the data server 131 via the AP 111.

The terminal 101 detects ambient APs using a sub STA in the AP switch processing in step S501.

In a case where the terminal 101 detects connectable APs other than the main AP using a sub STA in the AP detection processing in step S501 (Yes in step S502), the processing proceeds to AP comparison processing in step S503. In a case where the terminal 101 detects no connectable AP other than the main AP (No in step S502), the switch processing may be ended. In the case where the terminal 101 detects no connectable AP other than the main AP, the terminal 101 may execute the AP detection processing in step S501 using a sub STA again after a predetermined time passes.

The terminal 101 compares the connectable APs detected in the AP detection processing in step S501 with the main AP (step S503). The AP comparison processing in step S503 is executed using communication qualities such as the strength and the signal-to-noise ratio of radio waves received during the AP detection in step S501.

In the AP comparison processing in step S503, in a case where the communication quality of any connectable AP detected in step S501 is higher than the communication quality of the main AP (Yes in step S504), the processing proceeds to AP selection processing in step S505. In a case where the communication quality of the main AP is the highest, the AP switch processing is ended. In the case where the communication quality of the main AP is the highest, the terminal 101 may execute the AP detection processing in step S501 using the sub STA again after a predetermined time passes.

In a case where connectable APs with communication quality higher than the main AP are present in the AP comparison processing in step S503 (Yes in step S504), the terminal 101 selects an AP with the highest communication quality from the connectable APs as a sub AP to be connected using the sub STA (step S505).

The terminal 101 establishes a connection with the AP selected in the sub AP selection processing in step S505 using the sub STA in accordance with the procedure similar to the main STA connection processing in step S402 (step S506).

After establishing the connection with the sub AP using the sub STA, the terminal 101 changes the communication path via the main AP to the communication path via the sub AP (step S507). After the communication path is changed in the communication path change processing in step S507, the terminal 101 may disconnect the main AP.

Before the connection with the sub AP is established in such a manner, the communication qualities of the sub AP and the main AP are compared with each other. In this way, it is possible to prevent a connection with an AP with a communication quality inferior to that of a currently connected AP. After the switching of the AP to be used, an AP that is not used during data communication is disconnected. In this way, the AP switch processing can be efficiently executed next time. At the disconnection, ambient APs need to be detected using the connected STA more efficiently than at the connection.

In the second exemplary embodiment, the method is described for, before changing the communication path, comparing the communication qualities of a connectable AP and a main AP with each other using a sub STA so as to change the communication path via the main AP to the communication path via an AP with a communication quality higher than that of the main AP.

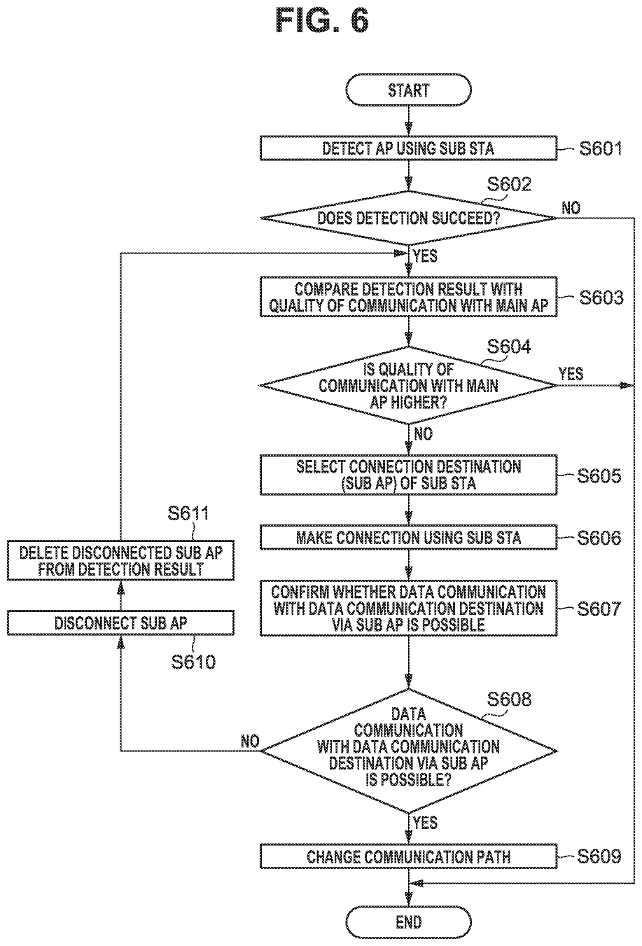

A third exemplary embodiment of the present disclosure is to be described. The configuration relating to the terminal 101 and the APs 111 and 112 is similar to those in FIGS. 1 and 2. In the present exemplary embodiment, the terminal 101 establishes the connection with the AP 111 to perform the data communication with the server 131 via the AP 111. Steps relating to the connection of the terminal 101 are similar to the steps in FIG. 4. FIG. 6 is a flowchart of a modification relating to the AP switch processing according to the present exemplary embodiment, and is an alternative to FIG. 5 in the second exemplary embodiment. The present exemplary embodiment is different from the second exemplary embodiment of FIG. 5 in that it is confirmed whether communication with a data communication destination that has performed communication via a main AP can be performed via a sub AP after a connection with the sub AP using a sub STA is established.

Also in the present exemplary embodiment, in the connection processing in step S402, the connection between the first STA 231 and the AP 111 is established. Also in the present exemplary embodiment, the definitions of the main STA, the sub STA, the main AP, and the sub AP are similar to those in the first and second exemplary embodiments. For this reason, also in the present exemplary embodiment, because the terminal 101 has already established the connection with the AP 111, the first STA 231 is the main STA, and the second STA 232 that is not used for the connection is the sub STA. The AP 111 that has established the connection with the first STA 231 as the main STA is the main AP. Further, a communication apparatus that performs data communication via the main AP is a data communication destination.

The AP switch processing in step S405 according to the present exemplary embodiment is to be described with reference to a flowchart 2 of the AP switch processing in FIG. 6. Steps S601 to S606 in FIG. 6 are similar to steps S501 to S506 in FIG. 5.

In the present exemplary embodiment, after STA connection processing in step S606, the terminal 101 confirms whether data communication with the data communication destination via a sub AP can be performed (step S607). Here, for example, the terminal 101 transmits an internet control message protocol (ICMP) packet to confirm whether the data communication with the data communication destination can be performed.

In a case where the data communication with the data communication destination can be performed via the sub AP after the confirmation processing in step S607 (Yes in step S608), the terminal 101 changes the communication path via the main AP to the communication path via the sub AP (step S609). Thereafter, the terminal 101 may disconnect the main AP upon the change of the communication path.

In a case where the data communication with the data communication destination cannot be performed via the sub AP (No in step S608), the terminal 101 disconnects the sub AP (step S610). After the disconnection of the sub AP, the terminal 101 deletes information about the disconnected AP from the detection results acquired in the AP detection processing in step S601 (step S611). After the information is deleted in step S611, in a case where the detection results in the AP detection in step S601 still remain, the terminal 101 may start the AP switch processing again from the AP comparison processing in step S603. In a case where no detection result remains, the AP switch processing ends.

In the present exemplary embodiment, after the connection with the sub AP using the sub STA is established, it is confirmed whether the data communication with the data communication destination via the sub AP can be performed. Thus, the data communication with the same data communication destination can be performed also after the AP is switched.

In the above-described second and third exemplary embodiments, the AP switch processing is executed by detecting that the quality of the communication with the connected AP fulfills the predetermined condition. The present disclosure, however, is not limited to these exemplary embodiments. For example, when the connection with the main AP is established by using the main STA, the AP detection processing may be executed by using the sub STA every predetermined time. In such a manner, the communication quality of an AP that is detected every predetermined time by using the STA that is not used for the data communication can be compared with the communication quality of the AP connected with the first STA periodically.

As a result, the AP switch processing may be started at timing when an AP with communication quality higher than that of the connected AP is detected. At this time, the AP detection steps S501 and S601 may be skipped. By detecting the connectable AP using the sub STA every predetermined time in such a manner, the connection can be established with the AP with higher communication quality periodically.

In the AP detection processing in the first, second, and third exemplary embodiments, the detection processing may be executed on all channels or selectively on some channels. Another condition may be added in the AP comparison processing.

For example, a minimum condition of the communication quality of a sub AP to be used may be provided. Even in a case where such conditions are added, the effect of the present disclosure can be attained. The present disclosure may be achieved by supplying a storage medium that records a program code of software for achieving the above-described functions to a system or an apparatus and causing a computer (CPU or MPU) to read and execute the stored program code. In this case, the program code itself read from the storage medium achieves the functions in the above-described exemplary embodiments, and the storage medium that records the program code is included in the present disclosure.

### Other Embodiments

Some embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-065948, filed Apr. 12, 2022, which is hereby incorporated by reference herein in its entirety.

What is claimed is:

1. A wireless communication apparatus including at least a first station (STA) and a second STA, the apparatus being connectable with at least a first access point (AP) and a second AP in parallel, the wireless communication apparatus comprising:
a detection unit configured to detect that a quality of communication with the first AP with which a connection is established fulfills a predetermined condition; and
a connection unit configured to establish a connection with the second AP using the second STA in a case where the detection unit detects that a quality of communication with the first AP fulfills the predetermined condition in a state that a connection with the first AP is established using the first STA.

2. The wireless communication apparatus according to claim 1, wherein the connection unit establishes a connection with a connectable AP as the second AP in a case where a quality of communication with the connectable AP using the second STA is higher than the quality of the communication with the first AP.

3. The wireless communication apparatus according to claim 2, further comprising a disconnection unit configured to disconnect the first AP after the connection with the second AP is established.

4. The wireless communication apparatus according to claim 2, further comprising:
a communication unit configured to perform data communication with another communication apparatus via an AP; and
a path change unit configured to change a communication path of the data communication with the another communication apparatus from a communication path via the first AP to a communication path via the second AP,
wherein the path change unit changes the communication path based on establishment of the connection with the second AP.

5. The wireless communication apparatus according to claim 4, wherein the path change unit does not change the communication path in a case where the data communication with the another communication apparatus via the second AP cannot be performed.

6. The wireless communication apparatus according to claim 2,
wherein the connection unit transmits a probe request frame, an authentication request frame, and an association request frame to the second AP, and
wherein the connection unit receives a probe response frame, an authentication response frame, and an association response frame transmitted from the second AP to establish the connection with the second AP.

7. The wireless communication apparatus according to claim 1, wherein the predetermined condition is a condition about a radio wave strength or a signal-to-noise ratio of a radio wave received from an AP.

8. The wireless communication apparatus according to claim 1, further comprising:
a print unit configured to print an image; and
a reception unit configured to receive image data to be printed via the first or second AP.

9. A control method of a wireless communication apparatus including at least a first station (STA) and a second STA, the apparatus being connectable with at least a first access point (AP) and a second AP in parallel, the control method comprising:
detecting that a quality of communication with the first AP with which a connection is established fulfills a predetermined condition; and
establishing, a connection with the second AP using the second STA in a case where it is detected that a quality of communication with the first AP fulfills the predetermined condition in the detecting in a state that a connection with the first AP is established using the first STA.

10. A storage medium storing a program configured to cause a computer to function as each unit of the wireless communication apparatus according to claim 1.
